(19) United States
(12) Patent Application Publication
(10) Pub. No.: US 2025/0096296 A1
(43) Pub. Date: Mar. 20, 2025

(54) FLOW BATTERY CELL AND METAL-AIR FLOW BATTERY

(71) Applicant: SHARP KABUSHIKI KAISHA, Sakai City (JP)

(72) Inventors: Hirotaka MIZUHATA, Sakai City (JP); Tomo KITAGAWA, Sakai City (JP)

(21) Appl. No.: 18/794,223

(22) Filed: Aug. 5, 2024

(30) Foreign Application Priority Data
Sep. 15, 2023 (JP) 2023-150471

(51) Int. Cl. H01M 8/18; H01M 8/22

(52) U.S. Cl. CPC H01M 8/188; H01M 8/225

(57) ABSTRACT

A flow battery cell includes: a positive electrode chamber; a negative electrode chamber opposite the positive electrode chamber; and a separator configured to separate the positive electrode chamber and the negative electrode chamber, wherein the negative electrode chamber includes: a negative-electrode flow path configured to distribute a slurry containing a metal active material and an electrolytic solution; and a negative electrode constituting a part of a wall face of the negative-electrode flow path, the negative electrode is disposed along a direction intersecting with a gravity direction and below the separator in terms of the gravity direction, and the metal active material is distributed in a sliding flow state in the negative-electrode flow path.

### CROSS-REFERENCE TO RELATED APPLICATION

The present application claims priority from Japanese Application JP2023-150471, the content of which is hereby incorporated by reference into this application.

### FIELD OF THE INVENTION

The present disclosure relates to flow battery cells and metal-air flow batteries.

### BACKGROUND OF THE INVENTION

Secondary batteries have been known that include, in an electrode thereof, a slurry containing an active material. As an example, Japanese Unexamined Patent Application Publication No. 2019-53868 describes a secondary battery including a positive electrode, a negative electrode, and an electrolytic solution, wherein the electrolytic solution contains, as an active material, at least one of metals selected from the group consisting of Zn, Li, Na, Mg, Al, Ca, Cr and Fe.

### SUMMARY OF THE INVENTION

### Problems to be Solved by the Invention

A flow battery, which is a type of secondary battery, includes a cell including a positive electrode, a negative electrode, and a separator interposed between the positive electrode and the negative electrode. The cell is fed with a positive-electrode active material and a negative-electrode active material for charging and discharging. The negative-electrode slurry, which is a negative-electrode active material, contains a metal active material and an electrolytic solution. If the metal active material and the negative electrode have a low contact efficiency, the reaction efficiency can fall, possibly leading to poor discharge characteristics.

The present disclosure has an object to provide a flow battery cell and a metal-air flow battery both of which can increase the reaction efficiency of the metal active material and the negative electrode.

### Solution to the Problems

The present disclosure is directed to a flow battery cell including: a positive electrode chamber; a negative electrode chamber opposite the positive electrode chamber; and a separator configured to separate the positive electrode chamber and the negative electrode chamber, wherein the negative electrode chamber includes: a negative-electrode flow path configured to distribute a slurry containing a metal active material and an electrolytic solution; and a negative electrode constituting a part of a wall face of the negative-electrode flow path, the negative electrode is disposed along a direction intersecting with a gravity direction and below the separator in terms of the gravity direction, and the metal active material is distributed in a sliding flow state in the negative-electrode flow path.

The present disclosure is directed to a flow battery cell including: a positive electrode chamber; a negative electrode chamber opposite the positive electrode chamber; and a separator configured to separate the positive electrode chamber and the negative electrode chamber, wherein the negative electrode chamber includes: a negative-electrode flow path configured to distribute a slurry containing a metal active material and an electrolytic solution; and a negative electrode constituting a part of a wall face of the negative-electrode flow path, and the negative electrode is disposed along a direction intersecting with a gravity direction and below the separator in terms of the gravity direction and satisfies 5×10\hat{ }−9≤Dₚ\hat{ }2/η<2.5×10\hat{ }−7, where the slurry has a viscosity given by η Pa·s, and the metal active material has a particle diameter given by Dₚ m.

A metal-air flow battery including the flow battery cell is also encompassed by the scope of the technical concept of the present disclosure and includes: a power generation unit including the flow battery cell; a storage unit configured to contain the electrolytic solution distributed in the power generation unit; and a charge unit to which the electrolytic solution is fed from the storage unit.

### Advantageous Effects of the Invention

The present disclosure enables increasing the reaction efficiency of the metal active material and the negative electrode.

### BRIEF DESCRIPTION OF DRAWINGS

FIG. 1 is a schematic illustration of a structure of a metal-air flow battery in accordance with an embodiment.

FIG. 2 is a schematic cross-sectional view of a flow battery cell in accordance with an embodiment.

FIG. 3A is a schematic cross-sectional illustration of an exemplary flow of a negative-electrode slurry distributed in a negative-electrode flow path in a flow battery cell.

FIG. 3B is a schematic cross-sectional illustration of another exemplary flow of a negative-electrode slurry distributed in a negative-electrode flow path in a flow battery cell.

FIG. 3C is a schematic cross-sectional illustration of yet another exemplary flow of a negative-electrode slurry distributed in a negative-electrode flow path in a flow battery cell.

FIG. 4 is a table of results of evaluation of precipitation separation and flow path occlusion for a negative-electrode slurry.

FIG. 5 is a graph representing a relationship between metal active material concentration and viscosity in negative-electrode slurries.

FIG. 6 is a graph representing a relationship between metal active material concentration and discharge capacity in negative-electrode slurries.

FIG. 7 is a graph representing a relationship between metal active material concentration and discharge characteristics in negative-electrode slurries.

FIG. 8 is a graph representing a cross-sectional flow rate and discharge characteristics in negative-electrode slurries.

FIG. 9 is a schematic cross-sectional view of a flow battery cell in accordance with an example of the disclosure.

FIG. 10 is a graph representing the discharge characteristics and cross-sectional flow rate of a negative-electrode slurry.

FIG. 11 is a graph representing the pressure loss and cross-sectional flow rate of a negative-electrode slurry.

FIG. 12 is a plan view of an exemplary flow path shape of a negative-electrode flow path.

FIG. 13 is a plan view of another exemplary flow path shape of a negative-electrode flow path.

### DESCRIPTION OF EMBODIMENTS

A description is given of a flow battery cell and a metal-air flow battery in accordance with an embodiment of the present disclosure with reference to drawings.

### Metal-Air Flow Battery

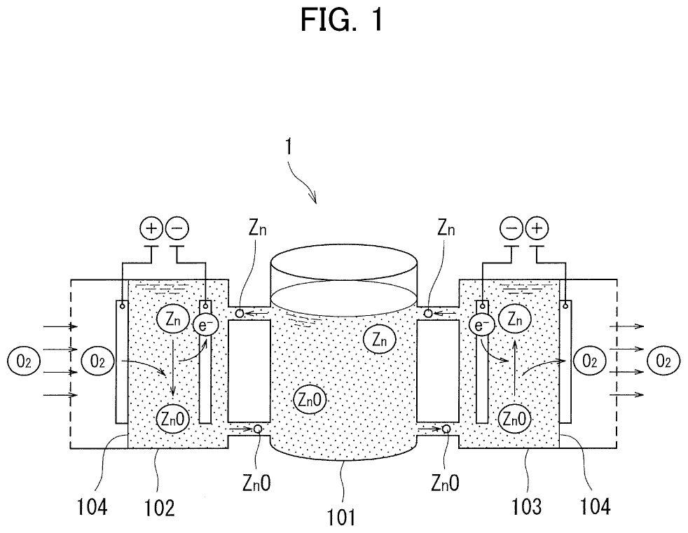

FIG. 1 is a schematic illustration of a structure of a metal-air flow battery 1 in accordance with an embodiment. Note that the members that are common to more than one embodiment described below are denoted by the same reference signs or numerals, and detailed description thereof may not be repeated.

As shown as an example in FIG. 1, the metal-air flow battery 1 includes a storage unit 101, a power generation unit (discharge unit) 102, and a charge unit 103. The metal-air flow battery 1 draws in air and generates electric power in the power generation unit 102 by utilizing the drawn-in air. The charge unit 103 charges electricity and ejects oxygen. The charge unit 103 is fed from the storage unit 101 with a negative-electrode slurry (slurry) that is a slurry-like fluid containing a negative-electrode active material and an electrolytic solution. Piping is provided connecting the storage unit 101 to the charge unit 103 to pneumatically transport, for example, the electrolytic solution via, for example, a pump. The same structure may be provided between the power generation unit 102 and the storage unit 101.

The storage unit 101 stores the negative-electrode slurry. The negative-electrode active material in the negative-electrode slurry contains: negative-electrode active material ions dissolved in an electrolyte; and a solid active material not dissolved, but suspended in the form of particles as a result of exceeding the saturation solubility in the electrolytic solution. The solid active material contains a reduced solid active material (metal active material) and an oxidized solid active material.

The negative-electrode active material is a metal species. The metal species is, for example, a zinc species, a cadmium species, a lithium species, a sodium species, a magnesium species, a lead species, a tin species, an aluminum species, or an iron species. The metal in the metal species may contain either only a metal that is the primary component or an alloy of a metal that is a primary component and a secondary component. The metal species may be either a metal or an oxide. Whether the metal species is a metal or an oxide is dictated by the progress of discharge reaction or charge reaction. It should be understood however that in the discharge reaction detailed later, the metal species is preferably in a reduced state.

In the present embodiment, the metal species is, for example, a zinc species, and the metal-air flow battery 1 is a flow zinc-air battery. The metal in the zinc species may be, for example, a metal containing only zinc as the primary component and may be, for example, an alloy of zinc as a primary component and a secondary component. When the metal species is zinc, the negative-electrode active material ions dissolved in the electrolyte are zincate ions, the reduced solid active material is zinc, and the oxidized solid active material is, for example, zinc oxide.

The metal species has an average particle diameter of a few micrometers when the metal species is an oxidized solid active material (e.g., ZnO) and of approximately from a few tens of micrometers to 200 micrometers when the metal species is a reduced solid active material (e.g., Zn). The average particle diameter can be measured using a particle counter. A particle counter measures a particle size distribution by, for example, laser diffraction or dynamic light scattering and calculates a median diameter D50 as the average particle diameter from the measured particle size distribution.

The electrolytic solution is selected in accordance with the metal species. When the metal species is a zinc species, the electrolytic solution is an alkali aqueous solution and may be, for example, an aqueous solution of potassium hydroxide or an aqueous solution of sodium hydroxide. When the metal species is a lithium species, the electrolytic solution is a non-aqueous electrolytic solution. When the metal species is a magnesium species, the electrolytic solution is a neutral aqueous solution and may be, for example, an aqueous solution of sodium chloride. The electrolytic solution may be replaced by a solid electrolyte.

The charge unit 103 is fed, at the negative electrode thereof, with the negative-electrode slurry from the storage unit 101. The charge unit 103 includes a separator 104 separating a region where the negative electrode is provided and a region where the positive electrode is provided.

When the metal species is zinc, the reaction at the negative electrode of the charge unit 103 is represented by chemical equations (1) and (2). At the negative electrode, first, zinc oxide, which is an oxidized solid active material, reacts with water and hydroxide ions, producing zincate ions. Then, the zincate ions receive electrons, producing zinc and hydroxide ions. The anions involved in a charge reaction and a discharge reaction (detailed later) are the hydroxide ions.

ZnO+H₂O+2OH⁻→Zn(OH)₄²⁻ (1)

Zn(OH)₄²⁻+2e⁻→Zn+4OH⁻ (2)

The reaction at the positive electrode of the charge unit 103 is represented by chemical equation (3). At the positive electrode, oxygen and water are produced from hydroxide ions, and electrons are released.

4OH⁻→O₂+2H₂O+4e⁻ (3)

The charge unit 103 is a zinc reproduction unit for charging by using zinc oxide which is an oxidized solid active material. The charge unit 103 is fed with a negative-electrode slurry containing a negative-electrode active material from the storage unit 101. The solid active material stored in the storage unit 101 and fed to the charge unit 103 is preferably in an oxidized state or preferably contains more oxidized solid active material than reduced solid active material.

The power generation unit 102 supplies the negative-electrode slurry from the storage unit 101 to the negative electrode and supplies air to the positive electrode. In the power generation unit 102, the separator 104 separates a region where the negative electrode is provided and a region where the positive electrode is provided.

In a flow zinc-air battery where the metal species is zinc, the reaction at the negative electrode of the power generation unit 102 is represented by chemical equations (4) and (5). At the negative electrode, zinc, which is a reduced solid active material, reacts with hydroxide ions, producing zincate ions and releasing electrons. The zincate ions produce zinc oxide, water, and hydroxide ions. The anions involved in a power generation reaction are hydroxide ions.

Zn+4OH⁻→Zn(OH)₄²⁻+2e⁻ (4)

Zn(OH)₄²⁻→ZnO+H₂O+2OH⁻ (5)

The reaction at the positive electrode of the power generation unit 102 is represented by chemical equation (6). At the positive electrode, electrons are received, and hydroxide ions are produced from oxygen and water.

O₂+2H₂O+4e⁻→4OH⁻ (6)

In the power generation unit 102, zinc, which is a reduced solid active material, is used for discharge. The power generation unit 102 is fed with a negative-electrode slurry containing a negative-electrode active material from the storage unit 101. The solid active material fed to the power generation unit 102 and stored in the storage unit 101 is preferably in a reduced state or preferably contains more reduced solid active material than oxidized solid active material.

### Flow Battery Cell

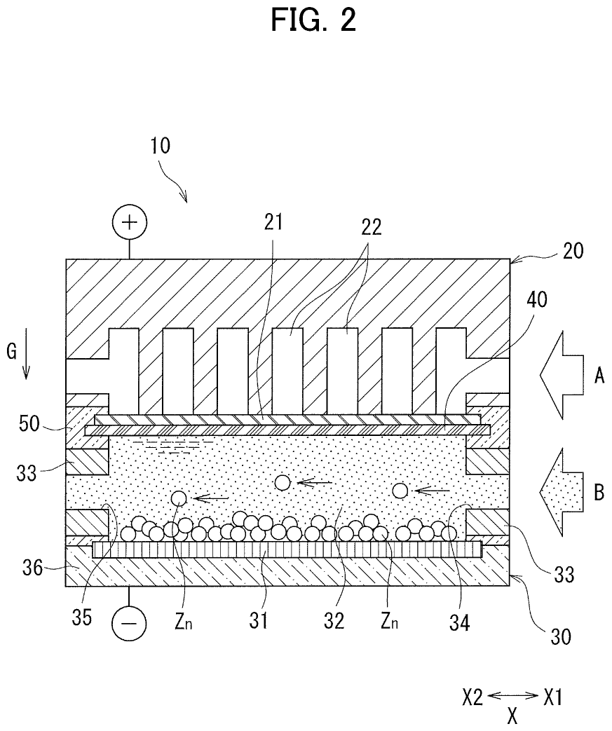

FIG. 2 is a schematic cross-sectional view of a flow battery cell 10 in the power generation unit 102 of the metal-air flow battery 1 in accordance with an embodiment.

In the metal-air flow battery 1, the power generation unit 102 includes basic structural units each being a flow battery cell (power generation unit cell) 10 including: a positive electrode chamber 20; a negative electrode chamber 30; and a separator 40 that separates these members. The flow battery cell 10 is of a flow-type in which a negative-electrode slurry B is distributed in a negative-electrode flow path 32 (detailed later).

The positive electrode chamber 20 includes a positive electrode 21 where an oxygen reduction reaction occurs. Air A containing oxygen, which is a reactant, is distributed in the positive electrode chamber 20. The positive electrode chamber 20 includes positive-electrode flow paths 22. The positive-electrode flow paths 22 are stripe-like grooves provided as flow paths for distributing oxygen, which is a positive-electrode active material.

The negative electrode chamber 30 includes a negative electrode 31 where an oxidation reaction of metal zinc occurs. The negative electrode 31 is disposed along an X-direction intersecting with gravity direction G. In the negative electrode chamber 30, the negative-electrode flow path 32 is provided through which the negative-electrode slurry B containing a metal active material and an electrolytic solution is distributed. The negative-electrode flow path 32 is a flow path through which the negative-electrode slurry B is distributed. For example, there is provided a negative-electrode flow path layer 33 between the negative electrode 31 and the separator 40, and the negative-electrode flow path 32 is formed by a groove in the negative electrode 31, the separator 40, and the negative-electrode flow path layer 33. Note that the negative-electrode flow path 32 is not necessarily provided by the groove-equipped, negative-electrode flow path layer 33. The flow path may be formed by, for example, a groove in the surface of the negative electrode 31.

The negative-electrode flow path 32 designates the X-direction intersecting with gravity direction G (perpendicular to gravity direction G in FIG. 2) as a distribution direction and is disposed along the X-direction. The negative-electrode flow path layer 33 provides an inlet port 34 for the negative-electrode slurry at an end of the negative-electrode flow path 32 and an outlet port 35 for the negative-electrode slurry at the other end of that negative-electrode flow path 32. The negative-electrode slurry B is distributed by the negative-electrode flow path 32 from the X1 side toward the X2 side.

The negative electrode 31 provides a part of the lower wall face of the negative-electrode flow path 32. The negative electrode 31 may be made of, for example, a conductive ingredient composed of a carbon material and a resin material. The separator 40, which is disposed opposite the negative electrode 31, provides a part of the upper wall face of the negative-electrode flow path 32. The separator 40 separates the positive electrode chamber 20 from the negative electrode chamber 30, thereby restraining the negative-electrode slurry from permeating from the negative electrode chamber 30 side to the positive electrode chamber 20 side. The separator 40 is disposed along the positive electrode 21. The separator 40 is preferably made of an ingredient suited to the restraining of the permeation of the negative-electrode slurry (e.g., a film of a hydrous gel). The separator 40 and the positive electrode 21 are supported and fixed by a sealing portion 50.

The negative electrode chamber 30 may include an electrical conduction plate 36 disposed along the negative electrode 31. The sealing portion 50 is disposed and fixed between the electrical conduction plate 36 and the negative-electrode flow path layer 33. Note that the negative electrode chamber 30 does not necessarily include the negative electrode 31, the electrical conduction plate 36, and the negative-electrode flow path layer 33, all these of which may alternatively be integrated into a single member.

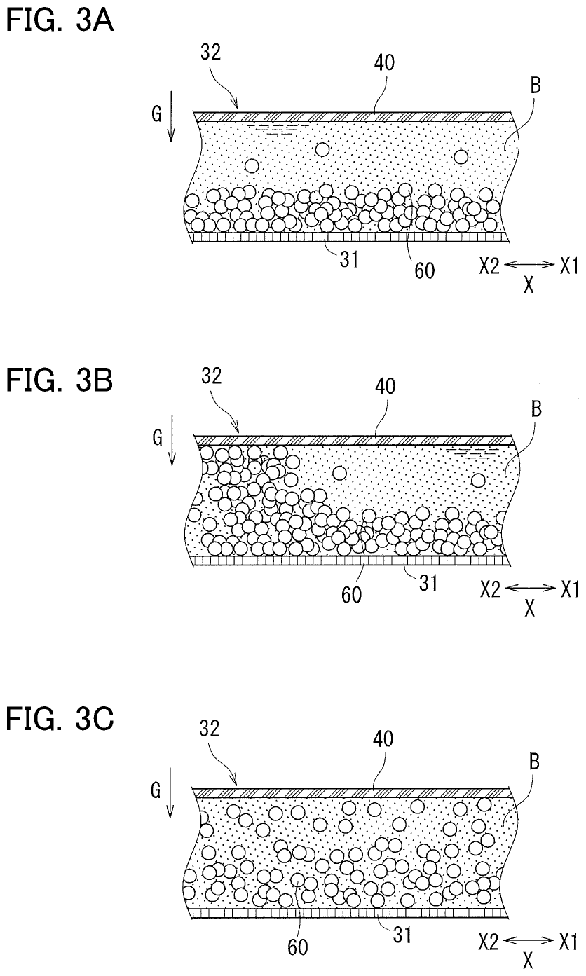

FIGS. 3A to 3C are schematic cross-sectional illustrations each of a different exemplary flow of a negative-electrode slurry distributed in a negative-electrode flow path.

In the flow battery cell 10, preferably, the negative-electrode slurry is satisfactorily distributed and stably transferred in the negative-electrode flow path 32, and the power generation unit 102 has its discharge characteristics enhanced. To enhance the discharge characteristics, it is desirable to enhance contact efficiency between the negative electrode 31 and the reduced solid active material (metal active material) in the distributed negative-electrode slurry.

For instance, as shown in FIG. 3A, when the negative-electrode slurry B containing a metal active material 60 and an electrolytic solution is fed to the negative-electrode flow path 32, in the negative-electrode flow path 32, the metal active material 60 can in some cases precipitate downwards in terms of gravity direction G and separate from the electrolytic solution, thereby possibly generating a difference in the concentration of the metal active material 60 between upper and lower layers of the negative-electrode flow path 32. In such cases, as shown in the drawing, it is desirable if the metal active material 60, which is separated and moved downwards from the upper layer of the electrolytic solution, deposits on the negative electrode 31 provided below the negative-electrode flow path 32, and the layer of the deposited metal active material 60 forms a sliding flow that gradually moves toward the X2 side, because this condition facilitates the enhancement of reaction efficiency between the metal active material 60 and the negative electrode 31.

Meanwhile, for example, as shown in FIG. 3B, if the fluid (slurry) acts insufficiently on the metal active material 60, the fluid (slurry) forms a deposition layer where the metal active material 60 does not move smoothly and therefore may remain on the X2 side, which may disadvantageously occlude the negative-electrode flow path 32. In addition, as shown in FIG. 3C, if the fluid (slurry) acts sufficiently on the metal active material 60, the fluid (slurry) can form a suspension flow by kicking up the metal active material 60 as the metal active material 60 is just about to deposit downwards in terms of gravity direction G, and the contact efficiency between the metal active material 60 and the negative electrode 31, which is disposed downwards in terms of gravity direction G, might fall, which could degrade the discharge characteristics.

According to a study of precipitation in the negative-electrode flow path 32 for the purpose of stable liquid transfer in the negative-electrode slurry, “terminal speed (precipitation rate) Vs” is calculated from Stokes equation (7) below. Note that in equation (7), Dₚ is the “average particle diameter (m) of primary component particles,” pp is the “density (g/cm³) of primary component particles,” and ρ_{f} is the “density (g/cm³) of a fluid.” Additionally, g is the “gravitational acceleration (m/s²)=980 cm/s²,” and η is the “viscosity (Pa·s) of a fluid.”

$$\begin{matrix}Math . 1 & \\ {V}_{s} = \frac{{D}_{p}^{2} ( {ρ}_{p} - {ρ}_{f} ) g}{18 η} & ( 7 )\end{matrix}$$

Stokes equation tells that negative-electrode slurries with a low viscosity η exhibit poor fluid action, hence possibly undesirably failing to form a sliding flow and stopping flowing, and also that negative-electrode slurries with a high viscosity η exhibit increased fluid action, hence more likely forming a suspension flow than forming a sliding flow. In addition, metal active materials with a large particle diameter Dₚ are likely to precipitate, hence failing to be transported. Metal active materials with a small particle diameter Dₚ are unlikely to precipitate, hence more likely forming a suspension flow.

In the current context, if the negative-electrode slurry has a low concentration, the quantity of the metal active material that comes into contact with the negative electrode 31 decreases, which degrades the discharge characteristics; if the negative-electrode slurry has a high concentration, the negative-electrode flow path 32 may be disadvantageously occluded. If the metal active material has a low density, the metal active material is unlikely to precipitate, hence likely forming a suspension flow; if the metal active material has a high density, the metal active material is likely to precipitate, hence failing to be transported. If the negative-electrode slurry has a low distribution velocity (cross-sectional flow rate), the negative-electrode slurry exhibits poor fluid action, hence possibly undesirably failing to form a sliding flow and stopping flowing; if the negative-electrode slurry has a high distribution velocity (cross-sectional flow rate), the negative-electrode slurry exhibits increased fluid action, hence more likely forming a suspension flow.

Accordingly, the flow battery cell 10 in accordance with the present embodiment is configured to mix a metal active material (e.g., zinc particles), a thickening agent (e.g., polyacrylic acid), and an electrolytic solution (e.g., aqueous solution of potassium hydroxide) for the negative-electrode slurry distributed in the negative electrode chamber 30 and to adjust the resultant mixture to the prescribed range described next, in order to enhance contact efficiency between the metal active material and the negative electrode for improved reaction efficiency.

In other words, the negative-electrode slurry is configured to satisfy inequality (8), where η Pa·s is the viscosity of the negative-electrode slurry, and Dₚ m is the particle diameter of the metal active material.

5×10\hat{ }−9≤Dₚ\hat{ }2/η<2.5×10\hat{ }−7 (8)

Throughout the following description of the present embodiment, “Dₚ\hat{ }2/η” in inequality (8) will be referred to as the characteristic expression d of the negative-electrode slurry (d=Dₚ\hat{ }2/η).

Here, in the process of using the metal-air flow battery 1, in the negative-electrode active material, zinc particles, which are a reduced solid active material, are oxidized to produce, for example, dissolved negative-electrode active material ions (zincate ions) and an oxidized solid active material (zinc oxide particles) deposited as a result of exceeding the saturation solubility. Therefore, the negative-electrode slurry contains, as the negative-electrode active material: the negative-electrode active material ions (zincate ions), which is a dissolved active material; a reduced solid active material (zinc particles) and an oxidized solid active material (zinc oxide particles), which are undissolved solid components; a thickening agent (polyacrylic acid); and an electrolytic solution (aqueous solution of potassium hydroxide). Among the reduced solid active material and the oxidized solid active material, the reduced solid active material is obtained as a residue by preferentially dissolving the oxidized solid active material in excess potassium hydroxide, based on the fact that the reduced solid active material dissolves far more slowly than the oxidized solid active material. Since this reduced solid active material is a metal active material, it is possible to measure, for example, its density and particle diameter. The solid active material and the solution component can be separated by centrifugation. This can be used to measure the density of the solution component.

By satisfying inequality (8) in the characteristic expression d of the negative-electrode slurry, when the metal active material has a large particle diameter and also when the negative-electrode slurry has a low viscosity, the terminal speed at which the metal active material precipitates in the negative-electrode slurry increases, causing the metal active material to deposit downwards in terms of gravity direction G inside the negative electrode chamber 30. The deposited metal active material exhibits an enhanced contact efficiency with an electrically conductive flow path surface disposed downwards in terms of gravity direction G (in other words, the negative electrode 31 in this case). This allows for an electron conduction path to form between various metal active materials and the negative electrode 31 owing to, for example, the contact within the metal active material and the contact of the metal active material and the electrically conductive flow path surface, which in turn enables restraining decreases in the discharge voltage.

In contrast, it is envisaged that when the characteristic expression d is too small in the characteristic expression d of the negative-electrode slurry, in other words, either when the particle diameter Dₚ of the metal active material is too small or when the viscosity of the negative-electrode slurry is too large, the precipitation rate of the metal active material falls, and therefore the metal active material is suspended in the negative-electrode slurry, which in turn reduces the contact efficiency with the negative electrode 31. Meanwhile, when the characteristic expression d of the negative-electrode slurry is large, in other words, either when the particle diameter Dₚ of the metal active material is too large or when the viscosity of the negative-electrode slurry is too small, the force that the fluid exerts on the metal active material decreases, as well as the precipitation rate of the metal active material increases, and therefore the metal active material stops being transported, which in turn could disadvantageously occlude the negative-electrode flow path 32.

Therefore, by disposing the negative electrode 31, which constitutes a part of the wall face of the negative-electrode flow path 32, along the X-direction intersecting with gravity direction G and also disposing the negative electrode 31 downwards in terms of gravity direction G to configure the negative-electrode slurry in the flow battery cell 10 so as to satisfy inequality (8), it becomes possible to improve the distribution of the negative-electrode slurry and enhance reaction efficiency between the metal active material and the negative electrode 31. Note that in the flow battery cell 10, the negative electrode 31 is not necessarily disposed in a direction perpendicular to gravity direction G and also that the negative-electrode flow path 32 does not necessarily have a distribution direction that is perpendicular to gravity direction G; both may be disposed along another direction such as any direction intersecting with gravity direction including an oblique direction intersecting with gravity direction.

### Example 1

Examples of the flow battery cell in accordance with the present disclosure and their comparative examples are now described.

As an example of the flow zinc-air battery in accordance with the present disclosure, an electrode was prepared and used as the positive electrode. The electrode was prepared by kneading and flattening acetylene black, which served as a conductor, and PTFE, which served as a water-repellent agent and as a binding agent, using manganese dioxide as a catalyst.

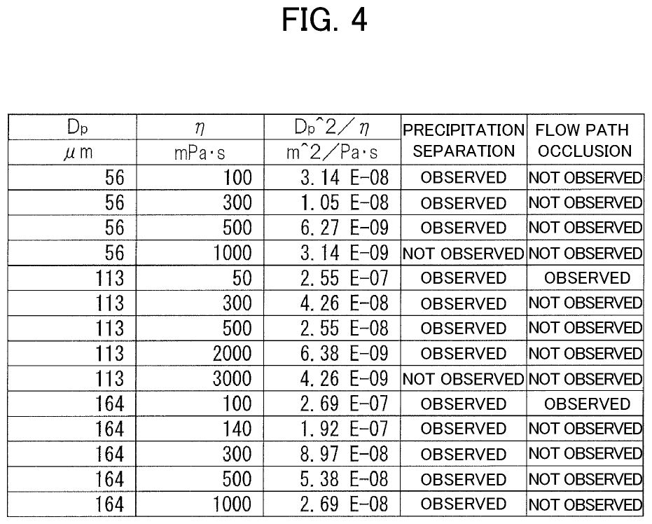

As negative-electrode slurries to be distributed in the negative-electrode flow path of a negative electrode chamber, negative-electrode slurries (50 cc) 20 wt % of which was metal active materials (zinc particles) with three different particle diameters Dₚ of 56 μm, 113 μm, and 164 μm and different viscosities n were prepared, stirred, and thereafter left to sit. The resultant negative-electrode slurries were observed for the progress of separation after being left to sit, to evaluate whether or not a supernatant layer of the electrolytic solution would appear with the progress of the precipitation of the metal active material when 20 minutes elapsed. In addition, it was evaluated whether or not the flow paths were occluded after the same negative-electrode slurries were distributed for 20 minutes by flow paths that were 100 mm in length and that had a 10 mm×4 mm rectangular cross-section. FIG. 4 shows results of the evaluation.

As Example 1, when the negative-electrode slurry satisfied the conditions that its characteristic expression d be from 5×10\hat{ }−9 to 2.5×10\hat{ }−7, both inclusive, precipitation separation was observed (precipitation separation: “observed”), and no flow path occlusion was observed (flow path occlusion: “not observed”), with any of these particle diameters and viscosities.

On the other hand, as a comparative example, when the viscosity was set to 1,000 mPa·s for some of the negative-electrode slurries containing a metal active material with a particle diameter of 56 μm, no precipitation separation was observed (precipitation separation: “not observed”). For the negative-electrode slurries with a particle diameter of 113 μm, flow path occlusion occurred (flow path occlusion: “observed”) when the viscosity was set to 50 mPa·s, and no precipitation separation was observed when the viscosity was set to 3,000 mPa·s. For the negative-electrode slurries with a particle diameter of 164 μm, flow path occlusion occurred when the viscosity was set to 100 mPa·s. None of these negative-electrode slurries satisfies the conditions that its characteristic expression d be from 5×10\hat{ }−9 to 2.5×10\hat{ }−7, both inclusive.

Therefore, in the flow battery cell, when the characteristic expression d of the negative-electrode slurry satisfies the above conditions, it is possible to cause precipitation separation in the negative-electrode slurry and hence generate a sliding flow as shown in FIG. 3A. Hence, the contact efficiency between the metal active material and the negative electrode can be increased, and stable liquid transfer can be achieved without causing flow path occlusion, which restrains pressure loss in the liquid transfer of the slurry.

### Example 2

In Example 2, negative-electrode slurries were prepared by mixing metal active materials (zinc particles) with a particle diameter (D50) of 164 μm in different weight fractions, to measure viscosity. For the electrolytic solution with 0 wt %, the viscosity was adjusted to 90 mPa·s or 4,500 mPa·s by using a thickening agent. Viscosity was evaluated using a Viscotester VT-06 manufactured by Rion Co., Ltd. The shear velocity dependence of viscosity was evaluated by changing the rotational speed of a B-type viscometer. The measurement using a viscotester VT-06 is substantially equivalent to the rotational speed of 60 on a B-type viscometer.

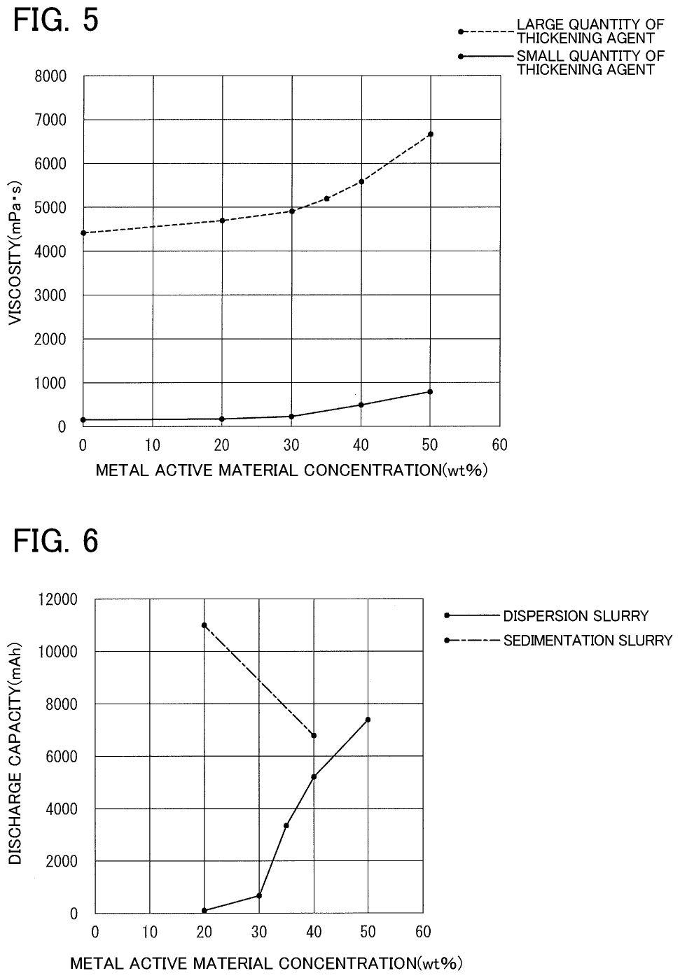

FIG. 5 is a graph representing a relationship between metal active material concentration (metal active material weight fraction) and viscosity in negative-electrode slurries. The graph demonstrates that the viscosity increases with an increase in the concentration of the metal active material. In addition, when the thickening agent was present in a large quantity, the viscosity exceeded 4,800 mPa·s, the metal active material was dispersed, and no precipitation separation of the metal active material was observed, whereas when the thickening agent was present in a small quantity, the viscosity was below 1,000 mPa, and precipitation separation of the metal active material was observed.

In other words, the slurry viscosity increases by dispersing the metal active material in the negative-electrode slurry. In particular, as the weight fraction of the metal active material increases, the viscosity also increases. Meanwhile, by reducing the viscosity of the negative-electrode slurry, the contact efficiency between the metal active material and the negative electrode can be increased even under metal active material conditions that the weight fraction be low, if the metal active material is allowed to deposit on the negative electrode.

Accordingly, discharge characteristics were evaluated using the negative-electrode slurries shown in FIG. 5. FIG. 6 is a graph representing a relationship between metal active material concentration and discharge capacity in negative-electrode slurries.

Referring to FIG. 6, the discharge capacity tended to be lower in dispersion negative-electrode slurries than in sedimentation negative-electrode slurries. In other words, in sedimentation negative-electrode slurries in which precipitation separation was observed, the obtained discharge capacity exceeded 6,000 mAh regardless of the metal active material concentration because the metal active material could be deposited on the negative electrode. Meanwhile, in the dispersion negative-electrode slurries for which no precipitation separation was observed, the discharge capacity was extremely low under the conditions that the metal active material concentration exceed 35 wt %, but tended to increase under the conditions that the metal active material concentration be less than or equal to 30 wt %, because there occurred no action of depositing the metal active material on the negative electrode so that the contact efficiency between the negative electrode and the metal active material was low.

Therefore, the discharge capacity largely depends on the viscosity of the negative-electrode slurry, in other words, the dispersibility of the metal active material. Sufficient discharge characteristics are not obtained under the conditions that the metal active material concentration be low under the conditions that the negative-electrode slurry have a high viscosity and the metal active material be dispersed. In the dispersion negative-electrode slurry, the characteristic expression d had a value of 4.4×10\hat{ }−9. In contrast, the sedimentation negative-electrode slurry had a high discharge capacity, and the characteristic expression d of the negative-electrode slurry had a value of 6.1×10\hat{ }−8, even when the metal active material concentration was low.

Hence, it is now verified that in the flow battery cell, when the negative-electrode slurry satisfies the conditions that the characteristic expression d be from 5×10\hat{ }−9 to 2.5×10\hat{ }−7, both inclusive, the contact probability between the negative electrode and the metal active material can be increased, and a high discharge capacity can be derived, even under the conditions that the metal active material concentration be low. Furthermore, a side benefit of enabling restraining pressure loss in the liquid transfer of the slurry is also achieved by restraining the viscosity of the negative-electrode slurry to a low level. It is also verified that the viscosity of the negative-electrode slurry at which the precipitation of the metal active material of the negative-electrode slurry proceeds and the metal active material can be deposited on the negative electrode is less than 1,000 m·Pa.

### Example 3

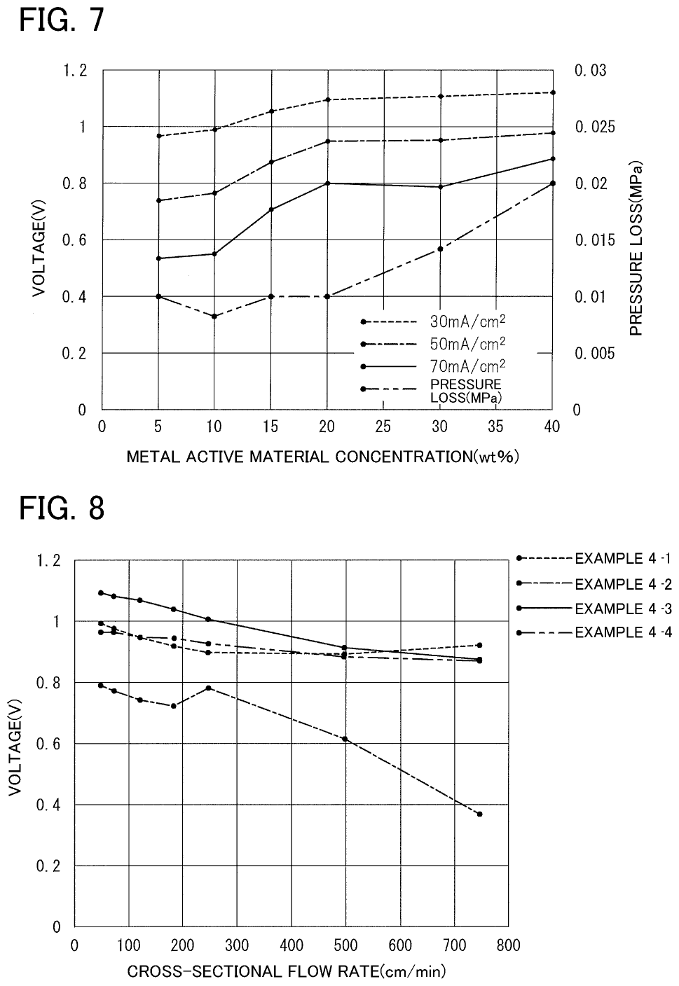

As described in Example 2, generally, it is envisaged that when the metal active material concentration is low, the discharge characteristics are degraded because the contact level between the negative electrode and the metal active material decreases. In Example 3, regarding a negative-electrode slurry having a relatively low metal active material concentration and containing a metal active material (zinc particles) in a ratio of from 5 wt % to 40 wt %, both inclusive, to the total quantity, a negative-electrode slurry was prepared from an electrolytic solution containing zinc particles with an average particle diameter of 50 μm as the metal active material and having a viscosity of 210 mPa·s. The prepared slurry was distributed in a negative-electrode flow path with a 10 mm×4 mm rectangular cross-section for a prescribed time. FIG. 7 is a graph representing a relationship between metal active material concentration and discharge characteristics in such a case.

FIG. 7 shows the following results. At a current density of 30 mA/cm², the voltage was 0.96 V when the weight fraction was 5 wt % and was approximately 1.0 V when the weight fraction was greater than or equal to 10 wt %. At a current density of 50 mA/cm², the voltage was 0.73 V when the weight fraction was 5 wt % and was 0.76 V when the weight fraction was greater than or equal to 10 wt %. Meanwhile, at a current density of 70 mA/cm², the voltage was 0.53 V when the weight fraction was 5 wt % and was as low as 0.54 V even when the weight fraction was greater than or equal to 10 wt %.

It is now verified that when the weight fraction is greater than or equal to 15 wt %, the voltage is greater than or equal to 0.70 V, and sufficient discharge characteristics are achieved, at all current densities. If the weight fraction is too high, the metal active material can disadvantageously occlude the negative-electrode flow path. For example, if the weight fraction increases to 40 wt %, the viscosity increases, and consequently, the pressure loss grows undesirably large in the liquid transfer of the negative-electrode slurry.

Therefore, the weight fraction of the negative-electrode slurry is preferably adjusted to contain zinc particles, which is a metal active material, in a ratio of from 15 wt % to 30 wt %, both inclusive, to the total quantity.

### Example 4

In Example 4, the discharge characteristics at various cross-sectional flow rates (the current density was 50 mA/cm²) were evaluated by using negative-electrode slurries with different characteristic expressions d. FIG. 8 is a graph representing the discharge characteristics of a flow zinc-air battery for each example of the present disclosure.

A negative-electrode slurry (Example 4-1) containing 20 wt % zinc particles with an average particle diameter 50 μm and having a viscosity of 210 mPa·s and a characteristic expression d of 1.2×10⁻⁸, a negative-electrode slurry (Example 4-2) containing 20 wt % zinc particles with an average particle diameter 50 μm and having a viscosity of 390 mPa·s and a characteristic expression d of 6.4×10⁻⁹, a negative-electrode slurry (Example 4-3) containing 20 wt % zinc particles with an average particle diameter 175 μm and having a viscosity of 230 mPa·s and a characteristic expression d of 1.3×10⁻⁷, and a negative-electrode slurry (Example 4-4) containing 20 wt % zinc particles with an average particle diameter 175 μm and having a viscosity of 330 mPa·s and a characteristic expression d of 9.3×10⁻⁸ were used.

In any of these examples, the negative-electrode slurry satisfied the conditions that the characteristic expression d be from 5×10\hat{ }−9 to 2.5×10\hat{ }−7, both inclusive, was free from flow path occlusion, and achieved good discharge voltages.

### Example 5

In Example 5, in addition to the arrangement of Example 1, the electrolytic solution of the negative-electrode slurry contained a thickening agent composed of a polymer material. The viscosity of the negative-electrode slurry was evaluated using a B-type viscometer to evaluate thixotropy.

In metal-air flow batteries, if the negative-electrode slurry is stored in a storage unit for a long time, the metal active material can either precipitate or sediment, and consequently the metal active material concentration may be disadvantageously non-uniform between the upper layer and the lower layer of the storage unit. Although the precipitation or sedimentation of the metal active material can be restrained by increasing the viscosity of the negative-electrode slurry to reduce the precipitation rate of the metal active material in the negative-electrode slurry during storage, the precipitation and deposition of the metal active material on the negative electrode does not proceed, which could be a cause for poor discharge characteristics, if the negative-electrode slurry is fed to the flow zinc-air battery.

A shear thinning property where viscosity decreases under shear force, for example, during liquid transfer as compared to the viscosity of the negative-electrode slurry being left to sit, for example, during storage can be imparted by using a polymer material such as a polyacrylic acid as a thickening agent as viscosity adjustment of the negative-electrode slurry. This is because if a polymer material is used as a thickening agent, the randomly oriented polymer is oriented along the flow so as to reduce viscosity.

In the negative-electrode slurry of which the viscosity is adjusted using a thickening agent composed of such a polymer material to impart a shear thinning property, the viscosity of the negative-electrode slurry decreases during liquid transfer, and the precipitation of the metal active material proceeds, when compared with during storage (while being left to sit). This type of thickening agent preferably contains a polymer material containing at least one species of site selected from acrylic acid, carboxy methyl cellulosic glucopyranose, β-D-mannuronic acid, α-L-guluronic acid, and acrylic methacrylate, such as polyacrylic acid, carboxy methyl cellulose, sodium alginate, or alkyl acrylate-alkyl methacrylate copolymer. Hence, the precipitation of the metal active material can be facilitated in the flow battery cell while restraining the concentration distribution of the metal active material when being left to sit, for example, during storage, which restrains decreases in the discharge voltage.

### Example 6

In Example 6, the flow rate of the negative-electrode slurry per unit cross-sectional area of the negative-electrode flow path was evaluated in the negative-electrode flow path arranged so as to satisfy the conditions that the characteristic expression d of the negative-electrode slurry be from 5×10\hat{ }−9 to 2.5×10\hat{ }−7, both inclusive, and configured so that the negative electrode of the negative electrode chamber intersects with gravity direction.

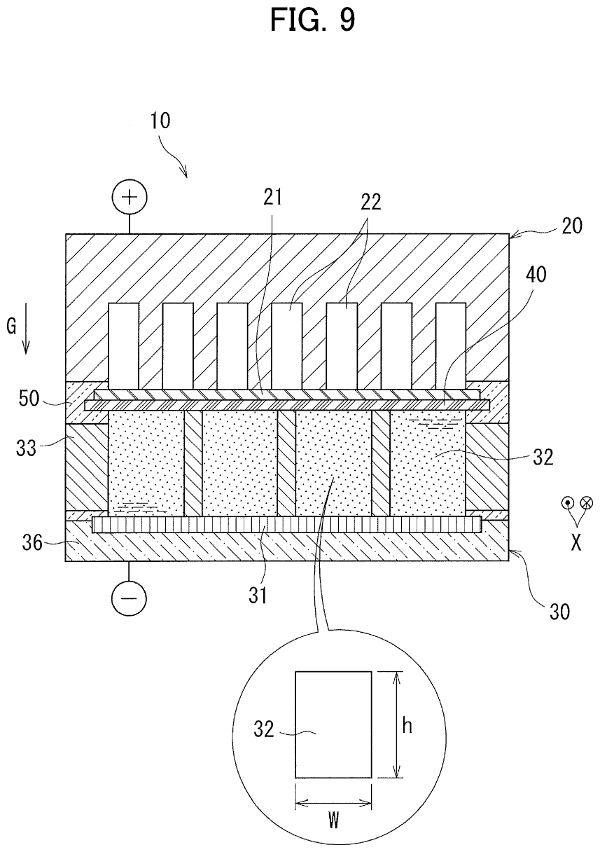

FIG. 9 is a schematic cross-sectional view of a flow battery cell in accordance with Example 6. FIG. 9 shows by means of a cross-section perpendicular to the distribution direction (X-direction; X2 direction in the example shown) of the negative-electrode slurry in the negative-electrode flow path 32 shown in FIG. 2. In such a case, the negative-electrode flow path 32 appears divided into a plurality of them between the separator 40 and the negative electrode 31 disposed downwards in terms of gravity direction G. The divided negative-electrode flow path 32 has a flow-path cross-sectional area of W·h as measured in a cross-section perpendicular to the distribution direction (X-direction) of the negative-electrode slurry, where h is a distance between the negative electrode 31 and the separator 40, and W is a flow path width of the negative-electrode flow path 32 perpendicular to the distance h.

As an example of the present disclosure, a negative-electrode slurry having an average particle diameter of 50 μm, containing zinc particles as a metal active material, and having a viscosity of 210 mPa·s was distributed in a negative-electrode flow path having a flow-path cross-sectional area W·h that had a 10 mm×4 mm rectangular cross-sectional shape. The zinc particles had respectively different metal active material concentrations ranging from 5 to 40 wt %.

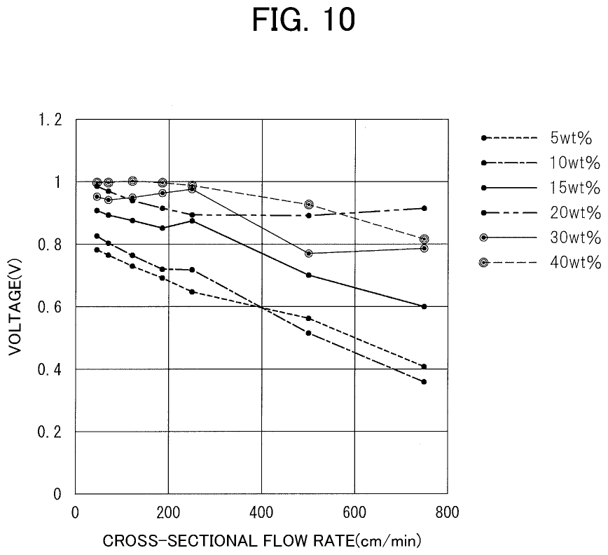

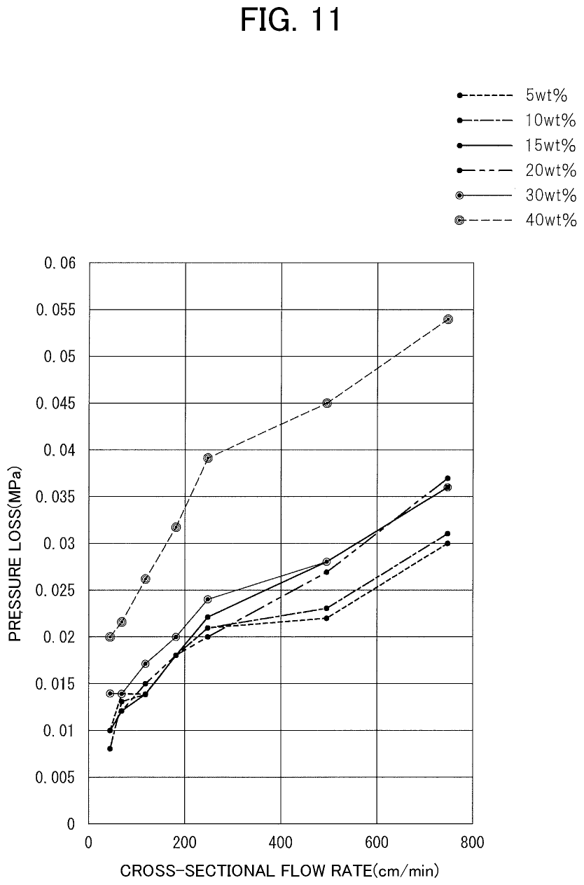

FIG. 10 is a graph representing the discharge characteristics (current density 50 mA/cm²) and the cross-sectional flow rate in a case where five negative-electrode slurries with different metal active material concentrations were distributed in the negative-electrode flow path. FIG. 11 is a graph representing their pressure losses and cross-sectional flow rates. In this case, if the cross-sectional flow rate is less than 75 cm/min, the drag that the flow exerts on the metal active material is small, and the metal active material may, for example, remain in the negative-electrode flow path and/or occlude the negative-electrode flow path. In addition, if the cross-sectional flow layer exceeds 500 cm/min, the fluid flow undesirably kicks up the metal active material that is about to deposit downwards in terms of the gravity direction (suspension flow), and the contact efficiency between the metal active material and the negative electrode disposed downwards in terms of the gravity direction decreases.

Therefore, in the flow battery cell, in the cross-section of the negative-electrode flow path perpendicular to the distribution direction of the negative-electrode slurry, the flow rate of the negative-electrode slurry that passes through the cross-section is preferably from 75 cm/min to 500 cm/min, both inclusive, per unit flow-path cross-sectional area.

As described here, by specifying the characteristic expression d of the negative-electrode slurry to satisfy the conditions that the characteristic expression d be from 5×10\hat{ }−9 to 2.5×10\hat{ }−7, both inclusive, and also setting the cross-sectional flow rate of the negative-electrode flow path to fall in the aforementioned range, the space above the negative electrode disposed downwards in terms of gravity direction G can be made into a state where the metal active material is distributed in a sliding flow state, without letting the metal active material occlude the negative-electrode flow path. As a result, for example, the contact within the metal active material and the contact between the metal active material and the negative electrode form an electron conduction path between the various metal active materials and the negative electrode, thereby enabling restraining decreases in the discharge voltage.

### Example 7

Referring to FIG. 9, in the flow battery cell 10, one of the wall faces of the negative-electrode flow path 32 is the negative electrode 31, and another one is the separator 40. A plurality of flow paths constituting a single negative-electrode flow path 32 are preferably disposed in the region where the negative electrode 31 faces the separator 40. In this case, distance (interval) h between the negative electrode 31 and the separator 40 and the flow path width W affect the pressure loss during liquid transfer of the negative-electrode slurry.

If the distance h between the negative electrode 31 and the separator 40 is less than 1 mm, the metal active material in the negative-electrode slurry comes into contact with each other, thereby likely remaining and possibly occluding the negative-electrode flow path 32. In addition, when this is the case, the pressure loss during liquid transfer could be disadvantageously large. Meanwhile, if the distance h between the negative electrode 31 and the separator 40 is greater than or equal to 6 mm, the distance “(½) h” between the central part of the negative-electrode flow path 32 in the distance h direction and the wall face of the negative-electrode flow path 32 grows longer, and the force that the flow exerts on the metal active material deposited on the negative electrode 31 becomes smaller. Therefore, no sliding flow state may be created where the metal active material is carried by the flow, and the metal active material could undesirably remain inside the flow path. In addition, since the negative electrode 31 is separated from the separator 40, the cell resistance grows larger.

In addition, although it is necessary to increase the flow rate per unit flow-path cross-sectional area when the negative-electrode flow path 32 provides a single flow path, if the flow path width W is too large, the flow of the negative-electrode slurry is likely to be non-uniform, which produces an irregular in-plane distribution of the metal active material and reduces the contact efficiency with the negative electrode 31. Therefore, the distance h between the negative electrode 31 constituting the wall face of the negative-electrode flow path 32 and the separator 40 opposite the negative electrode 31 is preferably from 1 mm to 6 mm, both inclusive.

In addition, With a view to produce a sliding flow in the negative-electrode flow path 32, the flow path width W of the negative-electrode flow path 32 perpendicular to the distance h is preferably constant because if the flow path width W of the negative-electrode flow path 32 is constant from the inlet port to the outlet port, no large flow rate changes occur.

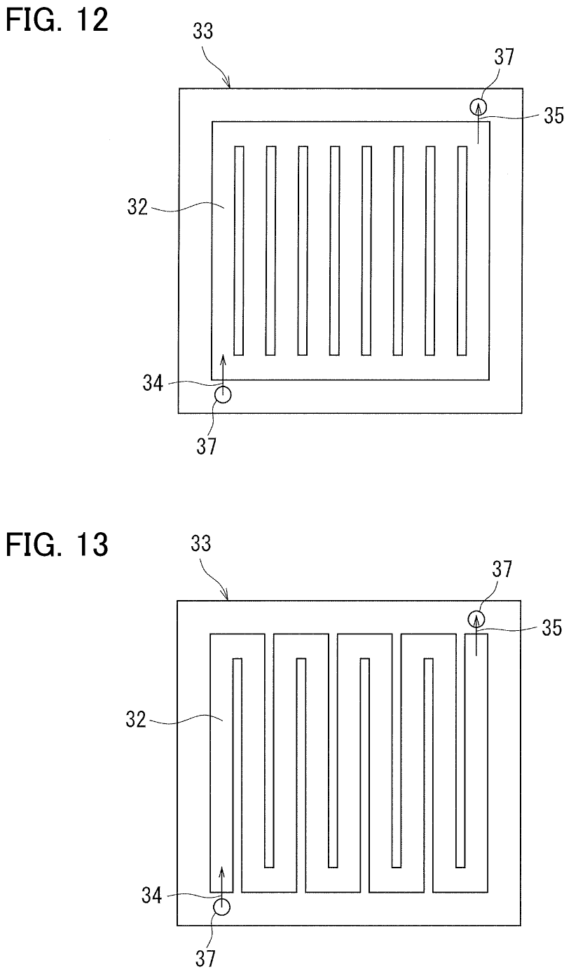

FIGS. 12 and 13 are plan views of a flow path shape of the negative-electrode flow path 32. As described above, the negative-electrode flow path 32 is provided by a groove formed in the negative-electrode flow path layer 33. The provision of the negative-electrode flow path layer 33 between the negative electrode 31 and the separator 40 forms a flow path with a flow-path cross-sectional area of W·h.

Here, as shown in FIG. 12, the negative-electrode flow path 32 includes branching flow paths, and this plurality of flow paths are connected in parallel. The negative-electrode slurry is distributed through the inlet port 34 of the negative-electrode flow path 32 and a negative electrode manifold 37 connected to the outlet port 35. If the negative-electrode flow path 32 has a flow path shape including such branching flow paths, large changes in the flow rate are likely before and after the branching points. Therefore, it may become difficult to produce a sliding flow of a negative-electrode slurry in the flow path region before the branching points and the flow path region after the branching points.

In contrast, the negative-electrode flow path 32 shown in FIG. 13 includes no branching flow paths between the inlet port 34 and the outlet port 35, hence providing a serpentine type of flow path structure in which a single flow path groove is repeatedly folded. In this case, a plurality of flow paths constituting the single negative-electrode flow path 32 can be provided in a region where the negative electrode 31 is positioned opposite the separator 40, which is preferable because the flow rate per unit flow-path cross-sectional area W·h can be increased without having to increase the total liquid quantity of the negative-electrode slurry fed to the flow battery cell. In addition, since the negative-electrode flow path 32 has no branching flow paths, there occur no large flow rate changes in the negative-electrode flow path 32, and a sliding flow can be produced throughout the negative-electrode flow path 32.

As described in the foregoing examples, the flow battery cells in accordance with the present disclosure enable enhancing contact efficiency between the metal active material and the negative electrode, thereby improving the distribution of the negative-electrode slurry and enhancing reaction efficiency between the metal active material and the negative electrode.

The present disclosure is not limited to the description of the embodiments and examples above. The present disclosure may be implemented in various forms without departing from its spirit and main features. All the technical matters included in the technical concept described in the patent claims are encompassed in the scope of the present disclosure. Although the above embodiments are described by way of preferred examples, various modifications may be realized from the disclosed contents, and such modifications are also included in the technical scope of the claims.

What is claimed is:

1. A flow battery cell comprising:
a positive electrode chamber;
a negative electrode chamber opposite the positive electrode chamber; and
a separator configured to separate the positive electrode chamber and the negative electrode chamber, wherein
the negative electrode chamber comprises:
a negative-electrode flow path configured to distribute a slurry containing a metal active material and an electrolytic solution; and
a negative electrode constituting a part of a wall face of the negative-electrode flow path, and
the negative electrode is disposed along a direction intersecting with a gravity direction and below the separator in terms of the gravity direction and satisfies 5×10\hat{ }−9≤Dp\hat{ }2/η<2.5×10\hat{ }−7, where the slurry has a viscosity given by n Pas, and the metal active material has a particle diameter given by Dp m.

2. The flow battery cell according to claim 1, wherein the metal active material is distributed in a sliding flow state in the negative-electrode flow path.

3. The flow battery cell according to claim 1, wherein the viscosity of the slurry is less than 1,000 m·Pa.

4. The flow battery cell according to claim 1, wherein the slurry contains the metal active material in a ratio of from 15 wt % to 30 wt %, both inclusive, relative to a total quantity.

5. The flow battery cell according to claim 1, wherein the slurry exhibits a shear thinning property.

6. The flow battery cell according to claim 1, wherein
the slurry contains a thickening agent, and
the thickening agent is a polymer material containing at least one species of site selected from acrylic acid, carboxy methyl cellulosic glucopyranose, β-D-mannuronic acid, α-L-guluronic acid, and acrylic methacrylate.

7. The flow battery cell according to claim 1, wherein the slurry, upon passing through a cross-section of the negative-electrode flow path that is perpendicular to a distribution direction of the slurry, has a flow rate of from 75 cm/min to 500 cm/min, both inclusive, per unit flow-path cross-sectional area of the cross-section.

8. The flow battery cell according to claim 1, wherein
the negative electrode constituting the wall face of the negative-electrode flow path and the separator opposite the negative electrode are separated by a distance h of from 1 mm to 6 mm, both inclusive, and
the negative-electrode flow path has a constant flow path width W perpendicular to the distance h.

9. The flow battery cell according to claim 1, wherein the negative-electrode flow path includes no branching flow path between an inlet port and an outlet port for the slurry.

10. A metal-air flow battery comprising:
a power generation unit including the flow battery cell according to claim 1;
a storage unit configured to contain the electrolytic solution distributed in the power generation unit; and
a charge unit to which the electrolytic solution is fed from the storage unit.
